(19) United States
(12) Patent Application Publication
(10) Pub. No.: US 2010/0076580 A1
(43) Pub. Date: Mar. 25, 2010

(54) Semiconductor integrated circuit design method for determining thickness of wiring based on plural factors contributing to thickness of wiring

(75) Inventor: Hiroshi Kitahara, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/585,339

(22) Filed: Sep. 11, 2009

(30) Foreign Application Priority Data
Sep. 22, 2008 (JP) 2008-242959

(51) Int. Cl. G06F 17/50

(52) U.S. Cl. 700/97; 716/14; 700/121

(57) ABSTRACT

A semiconductor integrated circuit design method, includes modeling a layer thickness of a wiring by a function including as independent variables, a percentage of surface area of the wiring in a first two-dimensional region where the wiring is formed, and a percentage of surface area for elements other than the wiring in a second two-dimensional region, and designing the wiring based on the wiring modeled.

This application is based upon and claims the benefit of priority from Japanese Patent Application No. 2008-242959 which was filed on Sep. 22, 2008, the disclosure of which is incorporated herein in its entirety by reference.

### RELATED OF THE INVENTION

1. Field of the Invention

The present invention relates to a semiconductor integrated circuit design method, and more particularly to a design method for wiring in semiconductor integrated circuits.

2. Description of Related Art

The thickness of wiring layers formed on the semiconductor integrated circuit is affected by the manufacturing process. The actual thickness of the wiring layer also deviates from the theoretical wiring layer thickness. As LSIs are made ever more highly integrated, errors in the wiring resistance and wiring capacitance due to these deviations from the theoretical wiring layer thickness become a problem.

In view of these circumstances, the capability to accurately predict the wiring contour based on a prediction formula capable of estimating in advance the amount of change in wiring layer thickness caused by effects from the manufacturing process, and estimate the wiring resistance and wiring capacitance, and utilize these (estimates) in the design of the semiconductor integrated circuit is needed.

In one example of the related art, the patent document discloses a technique for accurately modeling effects from the manufacturing process and estimating the wiring resistance and wiring capacitance with good accuracy during circuit design.

[Patent Document] Japanese Patent Application Laid Open No. 2003-108622

### SUMMARY

The present inventors rendered the following analysis.

The effect on the wiring contour due to polishing in the CMP (chemical mechanical polishing) process is modeled in the patent document. In this modeling, the wiring layer thickness Tcu can be given for example by: Tcu (W, S, D)=s*(D−0.5)+Tcu (W, S, 0.5) and D=w_X1*D_X1+w_X2*D_X2+w_X3*D_X3+ . . . . Here, W denotes the applicable wire width, S is the gap between the applicable wires, D is the wire data ratio in the periphery of the applicable wire (percentage of area occupied by wiring section surface on flat plane containing the wiring), s is the proportional constant, Tcu is the wiring layer thickness at a wiring data ratio of 0.5 (W, S, 0.5). Further, D_Xi is the wiring data ratio in the square-shaped region of the size Xi*Xi forming the center of the applicable wiring, W_Xi is the weight of the wiring data ratio D_Xi. The sum of all the weights W_Xi is 1. The proportional constant s expresses the erosion sensitivity of the wiring data ratio D, and is a value that varies according to process conditions.

FIG. 2 is a drawing for describing the method for finding the wiring data ratio. The wiring data ratio D is expressed by the weighted average of the wiring data ratio D_Xi (i=1, 2, . . . , N) in the region of size Xi set as the center of applicable wiring. Here, the wiring data ratio D_Xi, the weight w_Xi, the size Xi, and the number of regions N are set for each process.

However in the patent document, the wiring layer thickness Tcu is assumed to change uniformly (for example, uniformly decrease) as shown in FIG. 3A. The wiring layer thickness Tcu was in fact observed to show a trend to uniformly decrease along with an increase in the wiring data ratio D, due to effects from erosion in the related CMP process.

However in the CMP process utilized on more finely integrated semiconductor integrated circuits in recent years, the wiring layer thickness Tcu does not always change uniformly relative to the wiring data ratio D as shown in the diagram in FIG. 3B. For example, when implementing the CMP process for polishing the conductor and the CMP process for polishing the insulation layer, the former CMP process is predominant in locations with a high wiring data ratio, and the latter CMP process is predominant in locations with a low wiring data ratio, so that the wiring layer thickness exhibits complex behavior relative to the wiring data ratio.

However the model of the wiring layer thickness Tcu disclosed in the patent document cannot accurately predict these types of complex changes in wiring layer thickness. Consequently, large errors in the predicted values for wiring resistance and wiring capacitance occur during circuit design.

A semiconductor integrated circuit design method according to a first exemplary aspect of the present invention includes modeling a layer thickness of a wiring by a function including as independent variables, a percentage of surface area of the wiring in a first two-dimensional region where the wiring is formed, and a percentage of surface area for elements other than the wiring in a second two-dimensional region, and designing the wiring based on the wiring modeled.

A semiconductor integrated circuit design method according to a second exemplary aspect of the present invention includes: extracting a percentage of surface area of the wiring in a first two-dimensional region where the wiring is formed (hereafter called, “wiring data ratio”), and a percentage of surface area for elements other than the wiring in a second two-dimensional region (hereafter called, “non-wiring data ratio”) from a layout data; and substituting the extracted wiring data ratio and the extracted non-wiring data ratio into a function to model a layer thickness of the wiring including the wiring data ratio and the non-wiring data ratio as independent variables, in order to determine a layer thickness of the wiring.

A semiconductor integrated circuit design method according to a third exemplary aspect of the present invention includes determining a percentage of surface area of the wiring in a first two-dimensional region where the wiring is formed (hereafter called, “wiring data ratio”), so that a layer thickness of the wiring becomes a specified value, by utilizing a function that provides the layer thickness of the wiring using the wiring data ratio and a percentage of surface area for elements other than the wiring in a second two-dimensional region (hereafter called, “non-wiring data ratio”) as independent variables.

A method of forming a semiconductor integrated circuits according to a fourth exemplary aspect of the present invention includes determining a manufacturing process including a wiring manufacturing process for the semiconductor integrated circuit, modeling a layer thickness of a wiring by way of a function containing a percentage of surface area of the wiring in a first two-dimensional region where the wiring is formed (hereafter, “wiring data ratio”), and a percentage of surface area of elements other than the wiring in a second two-dimensional region (hereafter, “non-wiring data ratio”), as independent variables, determining a layout pattern of the wiring based on the wiring having the layer thickness modeled, and manufacturing the semiconductor integrated circuit including the layout pattern utilizing the manufacturing process.

A semiconductor integrated circuit according to a fifth exemplary aspect of the present invention includes a first region with a wiring arrayed uniformly so as to attain the specified wiring data ratio and a second region with a wiring uniformly arrayed so as to attain a different wiring data ratio and the first region and the second region are arrayed on the same plane.

A semiconductor integrated circuit design program product storing a program according to a sixth exemplary aspect of the present invention that executes in a computer, includes extracting a wiring data ratio and a non-wiring data ratio from a layout data, and substituting the extracted wiring data ratio and the non-wiring data ratio into a function for modeling a layer thickness of the wiring and including the wiring data ratio and the non-wiring data ratio as independent variables, and setting the layer thickness of the wiring.

The exemplary aspects are capable of providing a semiconductor integrated circuit design method that models the effects sustained by the wiring layer thickness in the manufacturing process with good accuracy and reduces errors in wiring layer thickness caused by the related techniques.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a flow chart of a semiconductor integrated circuit design method of an exemplary embodiment of the present invention;

FIG. 2 is a drawing for describing the method for calculating the wiring data ratio;

FIG. 3 is a concept view showing the dependency of a wiring data ratio on the wiring layer thickness;

FIG. 4 is a drawing for describing examples that take multiple two-dimensional regions into account for defining the wiring data ratio and the non-wiring data ratio;

FIG. 5 is a drawing for comparing the layer thickness acquired by the semiconductor integrated circuit design method of a first exemplary embodiment of the present invention with that acquired by the method of a related art;

FIG. 6 is a drawing for describing an example of a semiconductor integrated circuit of a second exemplary embodiment of the present invention;

FIG. 7 is a drawing showing an example of the data ratio of the semiconductor integrated circuit of the second exemplary embodiment of the present invention;

FIG. 8 is a flow chart of a semiconductor integrated circuit design method of a third exemplary embodiment of the present invention; and

FIG. 9 is a flow chart of a semiconductor integrated circuit design method of a fourth exemplary embodiment of the present invention.

### DETAILED DESCRIPTION OF THE EXEMPLARY EMBODIMENTS

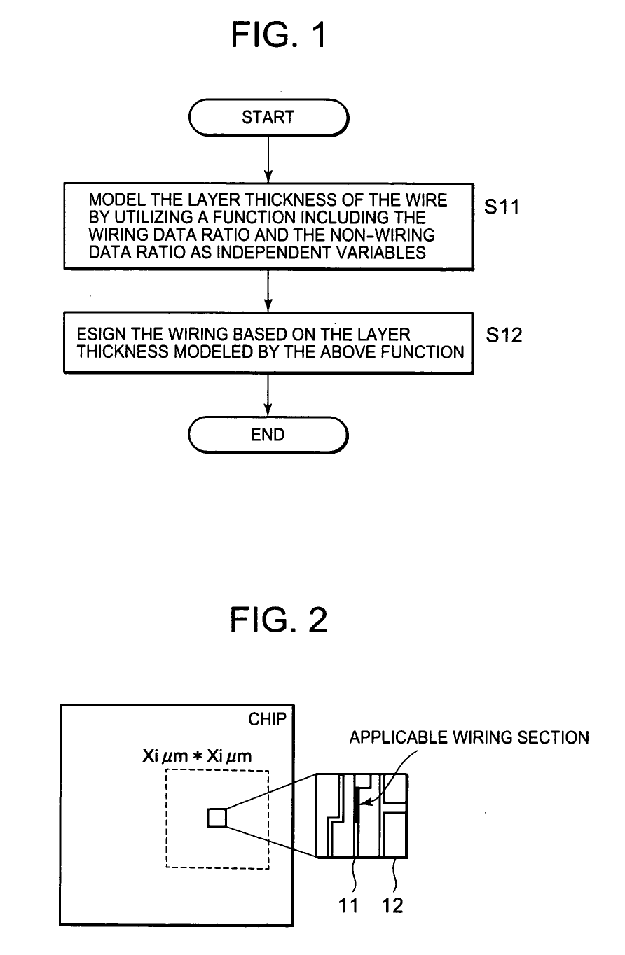

FIG. 1 is a flow chart of the semiconductor integrated circuit design method of an exemplary embodiment of the present invention.

In the semiconductor integrated circuit design method of the first exemplary embodiment as shown in FIG. 1, the layer thickness of the wiring is first of all modeled utilizing a function including a percentage of surface area (hereafter, “wiring data ratio”) of wiring in a two-dimensional region where the wiring is formed, and a percentage of surface area (hereafter, “non-wiring data ratio”) for elements other than the wiring in a two-dimensional region as independent variables (step S11). The wiring is next designed based on that wiring whose layer thickness was modeled by using that function (step S12).

A semiconductor integrated circuit design method according to a first mode may include a process for individually defining a first two-dimensional region for finding the wiring data ratio and, a second two-dimensional region for finding the non-wiring data region.

A semiconductor integrated circuit design method according to a second mode may include a process for defining multiple first two-dimensional regions of mutually different surface areas, and/or a process for defining multiple second two-dimensional regions of mutually different surface areas, and a process for separately setting the weights respectively for the multiple first two-dimensional regions and/or the second two-dimensional regions.

A semiconductor integrated circuit design method according to a third mode may include a function that preferably includes the sum of a first function and a second function and the first function contains the wiring data ratio in an independent variable and, the second function contains the non-wiring data ratio in an independent variable.

As a semiconductor integrated circuit design method according to a fourth mode, the first function may be a linear function for the wiring data ratio.

As a semiconductor integrated circuit design method according to a fifth mode, the second function may preferably be a linear function for the non-wiring data ratio.

A semiconductor integrated circuit design method according to a sixth mode may include a process for finding the wire contour based on the layer thickness set in the setting process and the layout data, and a process for extracting the wiring resistance and wiring capacitance based on the wiring contour that was found.

A semiconductor integrated circuit design method according to a seventh mode may include a process for placing dummy wiring according to the wiring data ratio set in the setting process.

### First Exemplary Embodiment

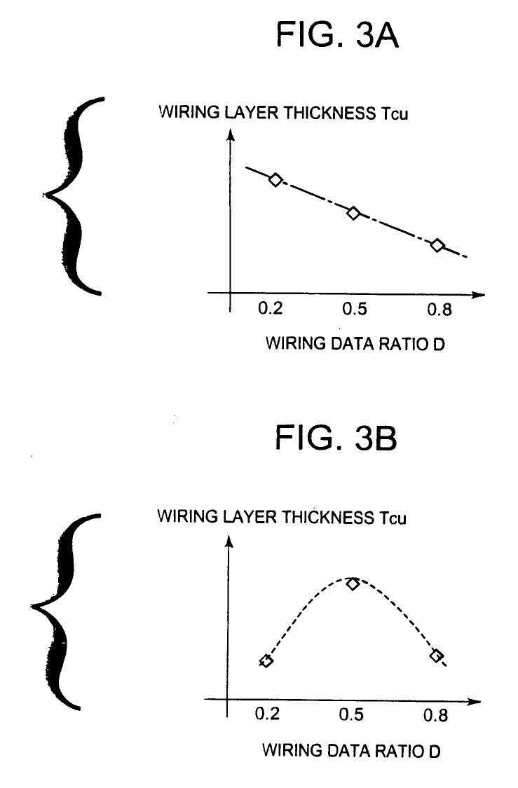

FIG. 3A and FIG. 3B are concept views showing the dependency on the wiring data ratio D of the wiring layer thickness Tcu obtained by the CMP process. When the wiring layer thickness Tcu is changing uniformly relative to the data ratio D as shown in FIG. 3A, this (change) indicates that the wiring layer thickness Tcu is determined by the CMP effects relative to a single factor (such as copper wiring).

FIG. 3B however shows that the wiring layer thickness Tcu does not uniformly increase or decrease but instead is a protruding shape. A wiring layer thickness that behaves as shown in FIG. 3B relative to the data ratio indicates that the wiring layer thickness is determined by multiple competing effects that CMP renders on the respective multiple factors (i.e., copper wiring and insulator film).

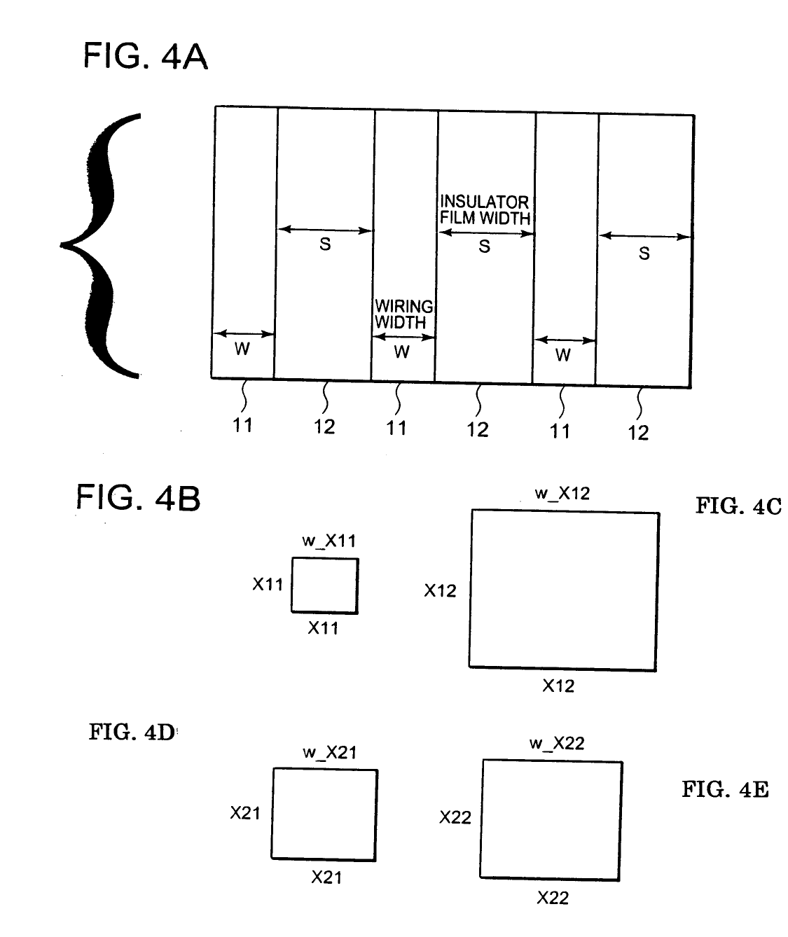

In the related model, the wiring film thickness Tcu is set only by the wiring data ratio D, as shown for example by Tcu (W, S, D)=s*(D−0.5)+Tcu (W, S, 0.5). When the wiring width is set as W, and the insulator film width is set as S as shown in FIG. 4A, then the wiring data ratio will be E=W/(S+W). However, accurate modeling is impossible when setting the wiring film thickness by multiple contributing factors as shown in FIG. 3B.

Whereupon, the above related model was expanded and the effects from CMP on the multiple respective factors (M items (Setting M≧2) were entered into the next formula of Tcu (D)=f1(D1)+f2(D2)+ . . . +fM(DM) for modeling the wiring layer thickness.

Here, the function fi (i=1, 2, . . . , M) is a function modeled by applying the i-th factor contribution to wiring layer thickness. Moreover, Di (i=1, 2, . . . , M) expresses the data ratio for the i-th factor. If expressing the data ratio Di of each factor i, by the weighted sum of the data ratio D_Xij for the multiple two-dimensional regions Xij (j=1, 2, . . . ) then the following is set:

D1=w_{—}X11*D_{—}X11+w_{—}X12*D_{—}X12+w_{—}X13*D_{—}X13+ . . .

D2=w_{—}X21*D_{—}X21+w_{—}X22*D_{—}X22+w_{—}X23*D_{—}X23+ . . .

DM=w_{—}XM1*D_{—}XM1+w_{—}XM2*D_{—}XM2+w_{—}XM3*D_{—}XM3+ . . .

Here, w_Xij expresses the weighting of data ratio D_Xij for the j-th two-dimensional region Xij of the i-th factor.

For example, when the wiring layer thickness is determined by the effects of CMP on oxidized film and the effects of CMP on copper wiring, then using a linear function to model the contributions of the respective factors on wiring layer thickness, could be achieved by employing a wiring layer thickness model expressed by the following formula.

Tcu(D)=f1(D1)+f2(D2)

f1(D1)=s1*(D1−0.5)+f1(0.5)

f2(D2)=s2*(D2−0.5)+f2(0.5)

Here, factor 1 is set as copper wiring, and factor 2 as oxide film. Also, f1 is the function expressing the copper wiring contribution to the wiring layer thickness, and f2 is a function expressing the oxide film contribution to the wiring layer thickness. Moreover, D1 denotes the data ratio of the copper wiring, and D2 denotes the data ratio of the oxide film.

As one example, along with expressing the copper wiring data ratio as a data ratio for a two-dimensional region with a size of X11*X11, and also by the weighted sum of the data ratio for a two-dimensional region with a size of X12*X12 (FIG. 4 B); the oxide film data ratio is expressed as a data ratio for a two-dimensional region with a size of X21*X21, and also by the weighted sum of the data ratio for a two-dimensional region with a size of X22*X22 (FIG. 4 C). Each factor of the data ratio can in this case be set as:

D1=w_{—}X11*D_{—}X11+w_{—}X12*D_{—}X12

D2=w_{—}X21*D_{—}X21+w_{—}X22*D_{—}X22

Here, the size X1j (j=1, 2) and the weight x_X1j of the two-dimensional region of the copper wiring can be selected independently of the size X2j (j=1, 2) and the weight w_X2j of the two-dimensional region of the oxide film.

The wiring layer thickness can be modeled with good accuracy even in cases where the wiring layer thickness has been set per multiple factors by the applied model as shown in FIG. 3B. In the case shown in FIG. 3B, the actual measured data and the above model can be combined by appropriately selecting the weights W_X11, w_X12, w_X21, and w_X22, and also the coefficients s1 and s2. Here, the model can be made to fit the actual measured data by implementing a technique of the known art (i.e., least squares method).

Though the example here described setting the wiring layer thickness by using the two factors of copper wiring and oxide film, the invention is not limited to two factors. The semiconductor integrated circuit design method of the exemplary embodiment is capable of modeling when setting the wiring layer thickness by utilizing an optional number of factors. The factor fi is not limited to a linear function. Moreover, this factor fi is not limited to polynomial functions.

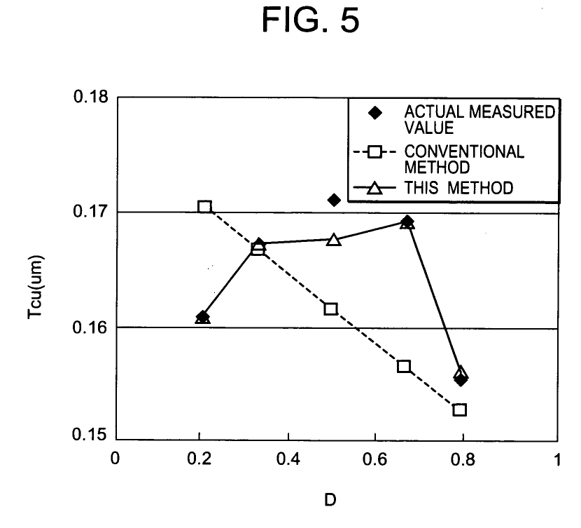

FIG. 5 shows a wiring layer thickness acquired by techniques of the related art and the exemplary embodiment as well as the actual measured value of the wiring layer thickness in a 55 nm device process. The error in wiring layer thickness between the methods of the related art and the actual measured value is −7.6% to +6.0%. However the error in wiring layer thickness between method of the exemplary embodiment and the actual measured value is −2.0% to +0.5%. The method of the exemplary embodiment therefore drastically improves the accuracy of the wiring layer thickness model compared to the method of the related art.

The method of the related art only considered one factor as the effect the CMP process renders on the wiring layer thickness. The method of the exemplary embodiment however suitably expresses the effect that multiple factors respectively exert on the wiring layer thickness and the acquired result is a good match with the actual measured value.

### Second Exemplary Embodiment

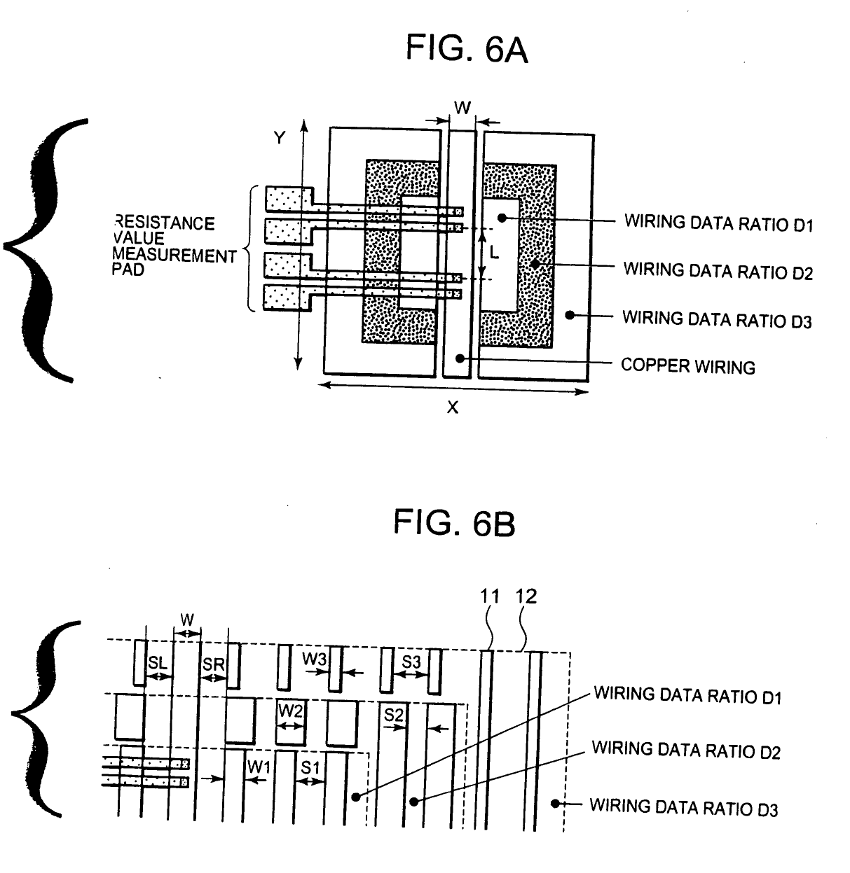

FIG. 6 is a drawing describing an example of the semiconductor integrated circuit of a second exemplary embodiment of this invention. FIG. 6B is an enlarged view of a portion of FIG. 6A. The semiconductor integrated circuit design method for example can efficiently extract parameters by utilizing TEG (test element groups) containing the semiconductor integrated circuits of the exemplary embodiment.

The semiconductor integrated circuit is a semiconductor integrated circuit suited for extracting parameters of wiring layer thickness models of the present invention. The wiring utilized for making the resistance measurements as shown in FIG. 6A is formed in the center of the semiconductor integrated circuit, and wiring whose wiring data ratio was adjusted is regularly distributed within that surrounding area. The two-dimensional region X*Y of the wiring formed in that periphery is set at a size covering a range where the applicable wiring sustains effects.

The wiring data ratio for each of the two-dimensional regions when including the wiring widths W1 through W3, and wiring intervals S1 through S3 for each of the two-dimensional regions as shown in FIG. 6B is:

D1=W1/(W1+S1)

D2=W2/(W2+S2)

D3=W3/(W3+S3).

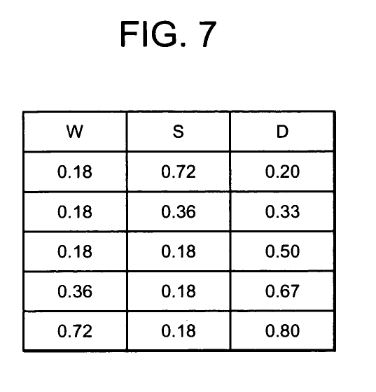

The data ratios D for several sets of wiring widths W and wiring intervals S acquired by the above functions are shown in FIG. 7. The wiring data ratios D1 through D3 are set in a range allowed by the design standards, the causes of fluctuations in the wiring layer thickness Tcu are analyzed in the CMP process, and patterns with extractable parameters are placed in the semiconductor integrated circuit as shown in FIG. 6.

The semiconductor integrated circuit can isolate the causes of fluctuations in the wiring layer thickness into separate parameters (namely W, S, D, Xi, etc.) by setting the wiring layer thickness using the patterns variously changed in respect to wiring width W, wiring gap S, wiring data ratio D, or the two-dimensional region size Xi. In the exemplary embodiment, the wiring layer thickness can therefore be evaluated not only as the data ratio D, but also the wiring width W, wiring gap S, or the function for the two-dimensional region size Xi. The semiconductor integrated circuit can therefore be utilized to develop processes where the fluctuations in the wiring layer thickness are small.

### Third Exemplary Embodiment

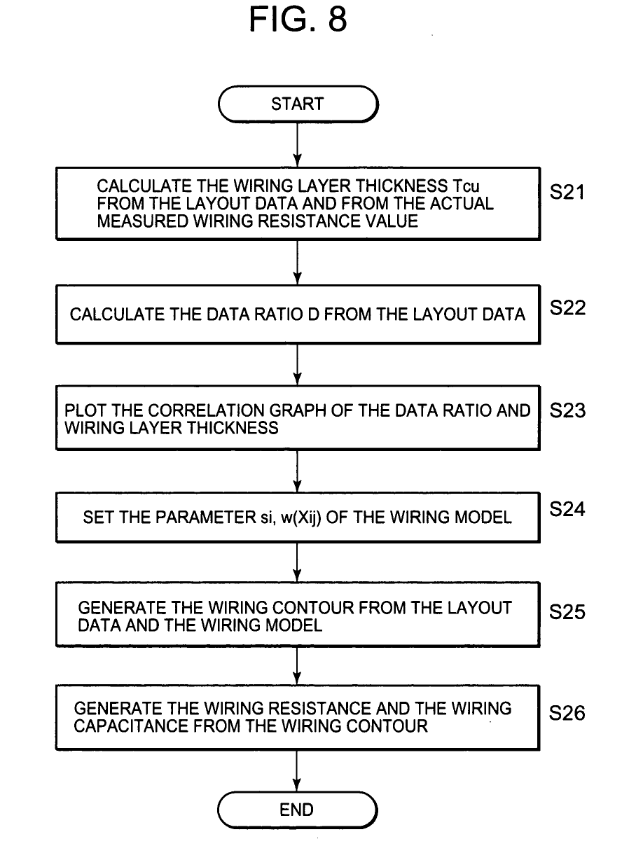

FIG. 8 is a flow chart of the semiconductor integrated circuit design method of a third present exemplary embodiment. In circuit design, the wiring capacitance and the wiring resistance are usually extracted by utilizing an LPE (Layout Parameter Extract) as the design tool, and a circuit simulation then implemented. The semiconductor integrated circuit design method incorporates a highly accurate wiring model of the related model into the LPE, as described in the first exemplary embodiment.

As shown in FIG. 8, an actual measured value for the wiring layer thickness Tcu is first of all calculated from the actual measured wiring resistance value and the layout data (i.e., wiring width W, wiring interval S) (step S21). The wiring data ratio D is next calculated from the layout data (step S22). These steps S21 and S22 may also be performed in the reverse order within the process. Moreover, the correlation graph for the calculated wiring layer thickness Tcu and data ratio D is also plotted (step S23).

The parameters included in each model (i.e. w_Xij, si, fi (0.5), etc.) are set next using the wiring layer thickness model of this invention so as to make a good re-creation of the wiring layer thickness and data ratio with the actual measured values (step S24). The wiring contour is then generated based on the layout data and the wiring model whose parameters were set (step S25). The wiring capacitance and wiring resistance are also generated from the generated wiring contour (step S26).

Compared to the method of the related art, the semiconductor integrated circuit wiring design method of the exemplary embodiment is capable of making high-accuracy layout verifications.

### Fourth Exemplary Embodiment

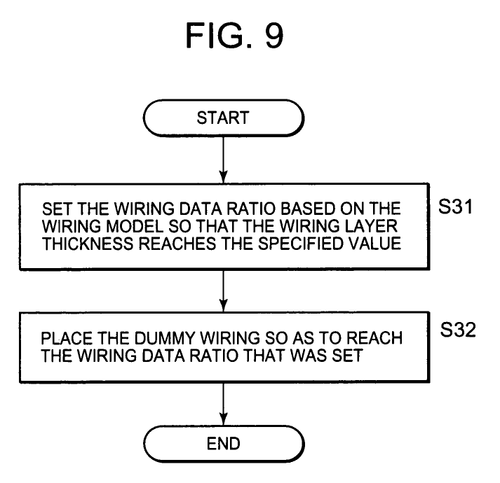

FIG. 9 is a flow chart of the semiconductor integrated circuit design method of a fourth exemplary embodiment of the present invention

The chip wiring density is generally limited to a value within a specified range due to production restrictions. Various tools (layout verification tools provided for example by an EDA vendor) are therefore utilized to insert a rectangular dummy pattern wiring in a fixed shape to keep the wiring density on the chip within a range that satisfies the production restrictions.

Based on the wiring model of the exemplary embodiment however, a wiring data ratio can be calculated that is capable of maintaining a uniform wiring layer thickness on the chip, and dummy wiring found that will serve as the applicable wiring data ratio.

In the exemplary embodiment, the wiring data ratio is first set so that the layer thickness of the wiring reaches a specified value, based on the wiring model of this invention (step S31). The dummy wiring is then placed so as to reach the wiring data ratio that was set (step S32).

Fluctuations in the wiring capacitance and wiring resistance caused by fluctuations in the height of the wiring on the chip can be suppressed by maintaining as uniform a wiring layer thickness as possible based on the wiring model of the present invention.

As explained the above, the exemplary embodiments can provide a method capable of modeling effects sustained by the wiring layer thickness from the CMP process with good accuracy and reduce errors in wiring layer thickness caused by the related techniques. Moreover, the exemplary embodiments can provide a semiconductor integrated circuit ideal for extracting a high-accuracy wiring model, a method for applying a layout verification tool to the applicable wiring model, and a method for inserting dummy wiring by way of the applicable wiring model.

Though the description related above was made based on the exemplary embodiments, the present invention is not limited by these exemplary embodiments.

Further, it is noted that Applicant's intent is to encompass equivalents of all claim elements, even if amended later during prosecution.

What is claimed is:

1. A semiconductor integrated circuit design method, comprising:
modeling a layer thickness of a wiring by a function including as independent variables, a percentage of a surface area of the wiring in a first two-dimensional region where the wiring is formed (hereafter called, “wiring data ratio”), and a percentage of a surface area for an element other than the wiring in a second two-dimensional region (hereafter called, “non-wiring data ratio”); and
designing the wiring based on the modeling.

2. The semiconductor integrated circuit design method according to claim 1, further comprising:
separately defining the first two-dimensional region and the second two-dimensional region.

3. The semiconductor integrated circuit design method according to claim 1, further comprising:
defining the first two-dimensional region into a plurality of first two-dimensional regions of mutually different surface areas;
defining the second two-dimensional region into a plurality of second two-dimensional regions of mutually different surface areas; and
separately setting weights respectively for the plurality of the first two-dimensional regions and the plurality of the second two-dimensional regions.

4. The semiconductor integrated circuit design method according to claim 1:
wherein the function includes a sum of a first function and a second function, and
wherein the first function includes the wiring data ratio as an independent variable and second function includes the non-wiring data ratio as an independent variable.

5. The semiconductor integrated circuit design method according to claim 4, wherein the first function comprises a linear function of the wiring data ratio.

6. The semiconductor integrated circuit design method according to claim 4, wherein the second function comprises a linear function of the non-wiring data ratio.

7. A semiconductor integrated circuit design method, comprising:
extracting a percentage of a surface area of the wiring in a first two-dimensional region where the wiring is formed (hereafter called, “wiring data ratio”), and a percentage of a surface area for an element other than the wiring in a second two-dimensional region (hereafter called, “non-wiring data ratio”) from a layout data; and
substituting the extracted wiring data ratio and the extracted non-wiring data ratio into a function to model a layer thickness of the wiring including the wiring data ratio and the non-wiring data ratio as independent variables, in order to determine a layer thickness of the wiring.

8. The semiconductor integrated circuit design method according to claim 7, further comprising:
obtaining a wiring contour based on the layout data and the layer thickness of the wiring; and
extracting a wiring resistance and a wiring capacitance based on the wiring contour.

9. A semiconductor integrated circuit design method, comprising:
determining a percentage of a surface area of a wiring in a first two-dimensional region where the wiring is formed (hereafter called, “wiring data ratio”), so that a layer thickness of the wiring becomes a specified value, by utilizing a function that provides the layer thickness of the wiring using the wiring data ratio and a percentage of a surface area for elements other than the wiring in a second two-dimensional region (hereafter called, “non-wiring data ratio”), as independent variables.

10. The semiconductor integrated circuit design method according to claim 9, further comprising:
placing a dummy wire according to the wiring data ratio.

11. A method of forming a semiconductor integrated circuit, comprising:
determining a manufacturing process including a wiring manufacturing process for the semiconductor integrated circuit;
modeling a layer thickness of a wiring by way of a function containing a percentage of a surface area of the wiring in a first two-dimensional region where the wiring is formed (hereafter, “wiring data ratio”), and a percentage of a surface area of elements other than the wiring in a second two-dimensional region (hereafter, “non-wiring data ratio”), as independent variables;
determining a layout pattern of the wiring based on the wiring having the layer thickness modeled; and
manufacturing the semiconductor integrated circuit including the layout pattern utilizing the manufacturing process.
